(19) United States
(12) Patent Application Publication
(10) Pub. No.: US 2025/0021866 A1
(43) Pub. Date: Jan. 16, 2025

(54) OPTIMIZED CROSS-VALIDATION FOR TIME-SERIES MODEL

(71) Applicant: SAP SE, Walldorf (DE)

(72) Inventor: Jacques DOAN HUU, Montigny le Bretonneux (FR)

(21) Appl. No.: 18/349,235

(22) Filed: Jul. 10, 2023

(51) Int. Cl. G06N 20/00

(52) U.S. Cl. CPC G06N 20/00

(57) ABSTRACT

Provided are systems and methods which optimize a validation process performed during training of a time-series forecasting model. The optimization can remove training data that has poor attributes for training (e.g., less error, less fluctuation, less patterns, etc.) to improve the quality of the training data and reduce the amount of processing that is performed by the host system. In one example, a method may include storing a plurality of machine learning models and a data set, dividing the data set into k folds of data, training the plurality of machine learning models on a subset of folds from among the k folds of data, determining error values for the plurality of machine learning models, respectively, based on fold errors among the subset of folds, and storing the error values within the storage.

### BACKGROUND

Time series data contains sequential data points (e.g., data values) that can be observed at successive time durations (e.g., hourly, daily, weekly, monthly, annually, etc.). For example, monthly rainfall, daily stock prices, annual sales revenue, etc., are examples of time series data. Sensors in combination with machine learning can be used to analyze the time series data and make predictions. For example, time series forecasting (or more simply “forecasting”) is a machine learning process which can be used to learn from historical values of time series data and predict future values of the time series data based on the learning. As an example, a forecasting process may output a graph of time series data as a plurality of data points over time (linear) that are displayed on a user interface for an analyst or other user to visualize and possibly take actions according to the prediction.

In order to build a time series forecasting model, the performance of the model must be evaluated in a robust way. One such validation technique is rolling cross-validation which splits a data set into several “folds” of data then trains the model on all of the folds of data except for a small subset of folds which are then used to test the trained model. In this case, the training process typically uses all of the folds for training and testing the model regardless of the nature of the data. This can be inefficient from a training perspective. For example, when the signal is nearly stationary and no significant structural changes are observed, the cross validation reports similar errors on the different test folds. This data may not provide much benefit (new information) for the model to learn from and it may require the computing system executing the model to consume significant resources. Furthermore, many time series forecasting models are retrained on a regular basis (e.g., daily, etc.) requiring continuing overconsumption of these resources.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating system for performing cross-validation of machine learning models during model selection in accordance with an example embodiment.

FIG. 2A is a diagram illustrating a process of training a model based on a first subset of a fold of data in accordance with an example embodiment.

FIG. 2B is a diagram illustrating a process of validating the model based on a second subset of the fold of data in accordance with an example embodiment.

FIG. 3 is a diagram illustrating an example of a k-fold data set for model training in accordance with example embodiments.

FIG. 4 is a diagram illustrating a process of determining folds of a data set for model training in accordance with example embodiments.

FIGS. 5A-5D are diagrams illustrating a process for training a plurality of models during model selection in accordance with an example embodiment.

FIG. 6 is a diagram illustrating a method of training machine learning models for model selection in accordance with an example embodiment.

FIG. 7 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Time series forecasting models are machine learning models that are used to predict a single set of values of an item (e.g., cost, quantity, amount, intensity, etc.) recorded over equal time increments (e.g., minutes, days, hours, weeks, years, etc.) The models may represent data attributes that are frequently found in business applications such as trends, seasonality, fluctuations, residuals, and time dependence. Model features may be trained based on available historical data. The trained model can then be used to forecast future values for the data. Some examples of time series forecasting models include exponential smoothing (ETS) and autoregressive integrated moving average (ARIMA) just to name a few.

Most time series forecasting models are univariate and attempt to learn a dynamically changing time series signal over time. To train a time series forecasting (TSF) model, a series of simulations of the model (e.g., time series forecasting algorithm, machine learning algorithm, etc.) are executed on training data (historically measured data values over time). The result is a model that can predict the normal output of the data pattern in the future. The training process works best when the training data includes periods of activity or fluctuating data points which tend to benefit the model more during the learning process in comparison to static or less fluctuating portions of the data/signal.

Once the model is built from historical training data, the model can then be applied on the future period to forecast how the signal would likely evolve over next h (horizon) future dates. The model's predictive accuracy is typically measured by comparing the predicted output to an actual/expected output which may be provided with the training data to determine the difference/error between the forecasted/predicted value generated by the trained model and the actual value that is already provided in the training data. Many modelling techniques exist in the TSF literature including, but not limited to, exponential smoothing. ARIMA, and the like. Each modelling technique generates a time series model with different components including level, trend, seasonality, auto-regressive, and the like.

Time series forecasting is widely deployed and utilized in business applications such as Enterprise Resource Planning (ERP), and the like. The models can be used to forecast future values of corporate key metrics which can be instrumental to optimize a business processes (supply chain, HR recruiting, etc.) Organizations that deploy time series forecasting as part of their business often configure a time series model to be retrained on a regular/iterative frequency such as daily, weekly, monthly, etc.

Time series data can vary widely. For example, a time series signal may exhibit a stationary pattern, an erratic pattern, a regular pattern, zero intermittent changes, abrupt trend changes, and the like. Because of this, there's a well-known theorem in machine learning known as “no free lunch” which provides that no single time series forecasting model (M) is capable of delivering the best predictive accuracy/output in all classes of problems, with respect to other TSF modelling techniques. Instead, the best practice in the industry is to train multiple models at the same time based on a particular training data set, and compare them (i.e., put them in competition with each other) in an effort to find the most accurate model for the training data. This practice ensures that a proper model is found in a wide diversity of situations.

The training of the models includes a validation process (e.g., cross validation, rolling cross validation, etc.) which determines a predictive accuracy of the trained models. For example, the training data may be split into a first subset of data that is used to train a model (or group of models), and a second subset of data that is used to test the performance of the trained model(s). As the historical data is frequently updated over time, the training may be performed by a scheduler on a host platform which schedules the training process for each of the different TSF models, determines error values of the models as a result of the training, and selects a model having the least error (best accuracy). The result is a very accurate model selection process that is fitted to the most current version of the data.

However, there is a significant processing cost that goes into training multiple time series forecasting models on a recurring basis. Furthermore, the results of the training may not improve the model and may even degrade the accuracy of the model when the underlying training data does not exhibit good patterns for model training (less error, consistently same error, etc.) That is, the retraining process can have little to no impact on the accuracy of the model. To address this problem in the art, the example embodiments select only an “optimal” subset of training data for training a machine learning model. The process reduces the amount of data that needs to be executed by the model (or group of models). It also reduces the load on the host platform. Furthermore, the model training process can be performed significantly faster.

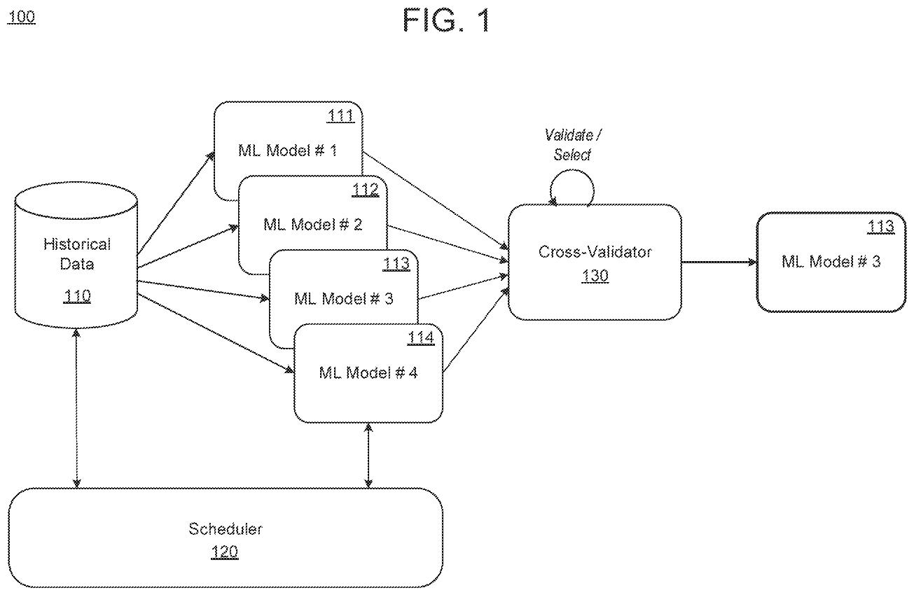

FIG. 1 illustrates a system 100 for performing cross-validation of machine learning models and model selection in accordance with an example embodiment. For example, the system 100 may be implemented within a software application or suite of software applications that are hosted on a platform such as a cloud platform, a web server, a database node, a combination of devices, or the like. Referring to FIG. 1, the system 100 includes a historical database 110 with historical training data for training a group of machine learning models, a scheduler 120, and a cross-validation module 130.

The historical database 110 may store a training data set that is continuously updated (e.g., daily, etc.) with actual data that occurs. As an example, a business may sell a particular widget. Sales of the widget over time may be used to predict the future sales of the widget. The predicted future sales can then be used to order supplies of the widget. As part of this process, the business data (e.g., sales date) may be stored within the historical database 110 and used to train/retrain a machine learning model to predict a demand for the widget in the future. Each day that goes by more sales data (training data) is added to the historical database 110 from sales data from the business. This additional data can be used to update/retrain the model to fit to the most current data patterns.

For example, in FIG. 1, the host system may train models 111, 112, 113, and 114, to perform the same task (e.g., predict demand, etc.) The machine learning models may include time-series forecasting models that have different attributes, algorithms, types, etc. The scheduler 120 may schedule training runs within a model pipeline (not shown). The pipeline may include one or more computers, virtual machines, etc., which provide a runtime environment for executing/training the machine learning models. The scheduler 120 may also dynamically select which training data to use for training each of the different models.

Once trained/retrained, the models 111, 112, 113, and 114 may be executed on additional data (validation data) from the historical database 110 to generate a predictive output based on the validation data. The historical database 110 may also provide an actual output that can be compared to the predictive output to determine how well the trained model performed. The process may be carried out by the cross-validation module 130. In this example, the cross-validation module 130 selects the model 113 with the best predictive accuracy identified via an optimized cross validation process. Examples of the optimized cross validation process are further described herein.

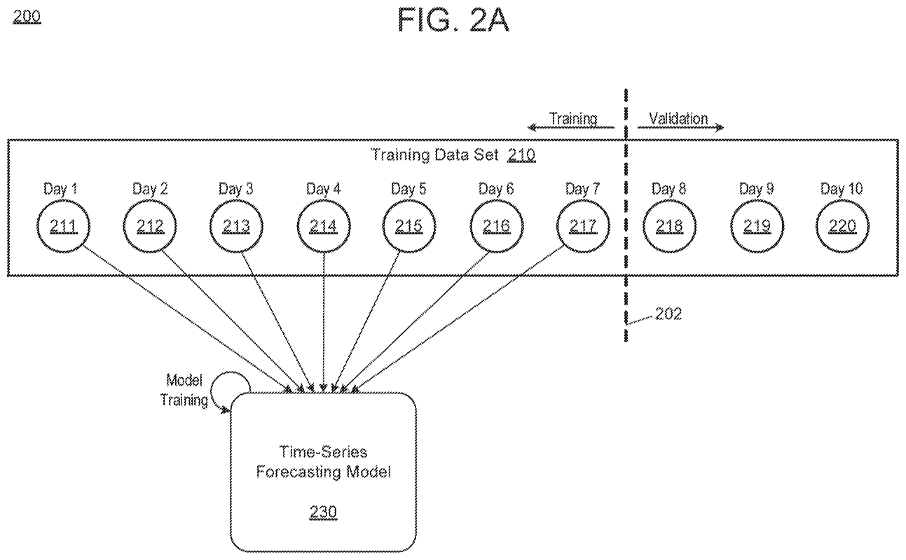

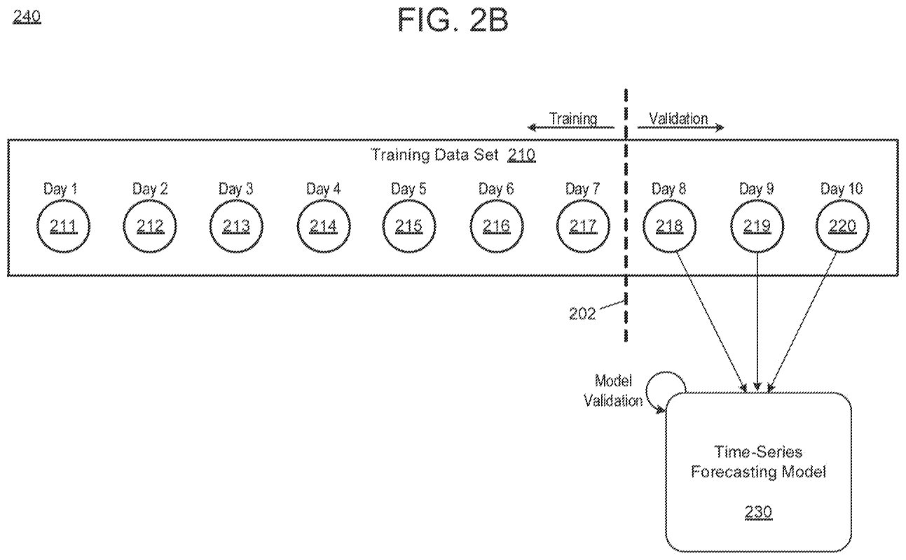

FIG. 2A illustrates a process 200 of training a time-series forecasting (TSF) model 230 based on a first subset of a fold of data in accordance with an example embodiment, and FIG. 2B illustrates a process 240 of validating the TSF model 230 after training based on a second subset of the fold of data in accordance with an example embodiment. Referring to FIGS. 2A and 2B, a training data set 210 includes a sequence of data points 211, 212, 213, 214, 215, 216, 217, 218, 219, and 220. The training data set 210 may also be referred to herein as a “fold” of data.

The data points within the training data set 210 may include numerical values such as tabular data representing numbers that are based over time. As just an example, temperature of a room may be measured by a sensor on a recurring basis over time. As another example, sales data from a business may be captured on a recurring basis over time. In this example, each day represents an additional data value or group of values which can be used to train a machine learning model. The data points 211-220 are unseen by the models at this point.

Here, the host platform may bifurcate the data points at a point 202 within the training data set 210 (fold) to generate a first subset of data points 211-217 for model training, and a second subset of data points 218-220 for validation of the trained model. Accordingly, the host system may execute the TSF model 230 on the first subset of data points 211-217 within a runtime environment to further train the model. In addition, the host system may execute the TSF model 230 (once trained), on the second subset of data points 218-220 to generate a predictive output that can be compared to an actual output within the training data set 210 (not shown). Thus, the TSF model 230 can be trained based on the first subset of data points 211-217 and tested/validated based on the second subset of data points 218-220.

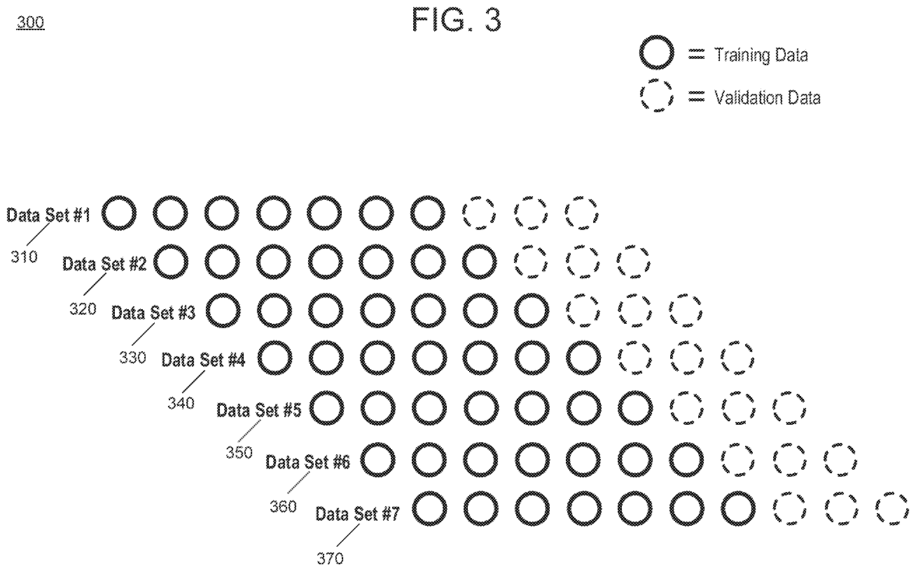

FIG. 3 illustrates an example of a data set 300 for model training in accordance with example embodiments. Referring to FIG. 3, the data set 300 includes a plurality of folds 310, 320, 330, 340, 350, 360, and 370. Each fold includes a first subset of data points for model training and a second subset of data points for model validation. Here, the data set 300 may be referred to as a “k-fold” data set where “k” represents the number of folds in the data set. In this example, there are seven folds of data (k=7) representing seven different sequences of time series data from an organization. This is a common training data set for organizations that update their TSF models on a regular basis. As an example, each of the folds may include a sequence of data values such as a sequence of readings/values from a sequence of days, etc. The folds may include partially overlapping data sets, mutually exclusive data sets, and the like.

In FIG. 3, the plurality of folds 310 may be referred to as a “rolling” data set since each fold includes a rolling window of data from the overall data set. This process slowly changes the model by adding one new data point and removing one old data point each day. It should be appreciated that other or different rolling windows of data are also possible with different rates of removal, rates of overlap between folds, different numbers of folds, etc.

In other words, rather than have a single experiment with a split between estimation and validation, the model selection process described herein performs multiple experiments (multiple models) on multiple splits of data (folds) to ensure a more robust error measurement because the error may vary significantly depending on the arbitrary cutoff point choice. The process is referred to as cross validation or rolling cross validation. The rolling qualification indicates that the origin (cutoff point between estimation and validation) is moving forward over time.

However, training a model or a group of models using the entire training data set 300 shown in FIG. 3 is likely not going to be efficient. For example, if the host system were to train/retrain a plurality of models such as the models 111, 112, 113, and 114 shown in FIG. 1, using the training data set shown in FIG. 3, the host would likely perform a significant amount of unnecessary or unhelpful training because many of the new data points are similar to existing data points, and therefore provide little to no value for purposes of machine learning.

According to various embodiments, the host system described herein may dynamically determine a subset of folds of data to use for training the plurality of models and then determine whether additional training is necessary. For example, the host system may compare fold errors between the subset of folds used for training to determine if enough error exists to warrant additional training using additional folds from the training data. For example, the error ratio may be calculated and compared to a threshold. When the host system determines that the error is not significant enough, the training process can end without the host system ever executing the model on the remainder of the training data set. As a result, a significant amount of training time can be removed. Furthermore, the model accuracy is not affected much by removal of this data because the data provides little to no value for machine learning.

In many cases, TSF model training/retraining is scheduled every day by the schedule and includes a rolling cross validation. During the training process, the historical data is only expanded with no alteration and the estimation size is fixed with a sliding window. The rolling cross validation consists in moving ahead the origin which produces overlapping fold error evaluations. The optimization principle is therefore straightforward considering above redundancy observation. After updating/retraining a model within a fold of data, the host system identifies a fold error (difference with a previous fold) and stores it into a storage.

The entries stored in the storage may include fields for TSF pipeline identifier and version, model identifier, forecasting horizon identifier, start/end dates for both estimation and validation (fold) datasets, a hash code of the signal values for both estimation and validation datasets, and the like. The hash code is a common technical trick to generate a short and fixed-size code from a sequence of arbitrary values to have a fast routine for comparison.

On the next execution of the TSF pipeline, the host may build the composite keys of all fold errors to evaluate. If the fold error is present in the cache, the host system may fetch the cached error and skip consequently the fold error evaluation which requires the training of all model candidates. The fold error storage may be purged by deleting out of dates entries: for each fold error entry, a field records the last date where the fold error entry has been utilized. If a cache entry is not used beyond a certain delay (administration configuration), it's then declared as out of date and purged.

The model training/retraining process described herein may be performed for one or more models. In some examples, the process may be performed for a plurality of TSF models (e.g., M1, M2, M3, and M4, etc.) which are each candidates for model selection. However, training and validating each of the TSF models on an entire set of data such as shown in FIG. 3. consumes significant resources.

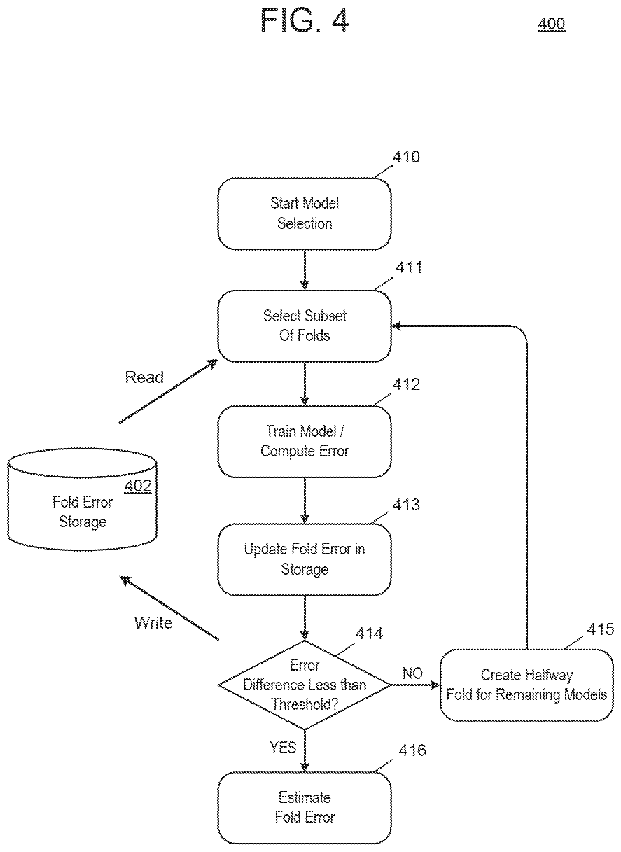

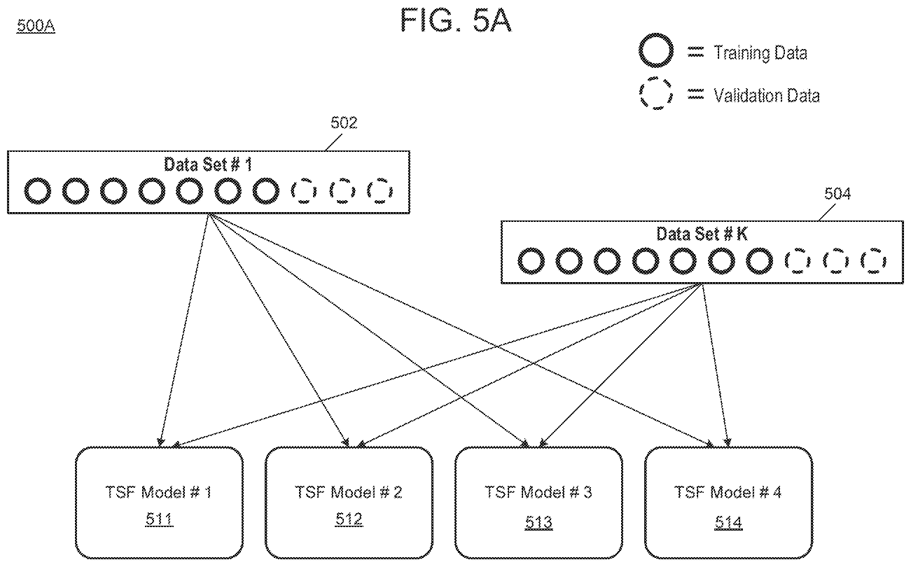

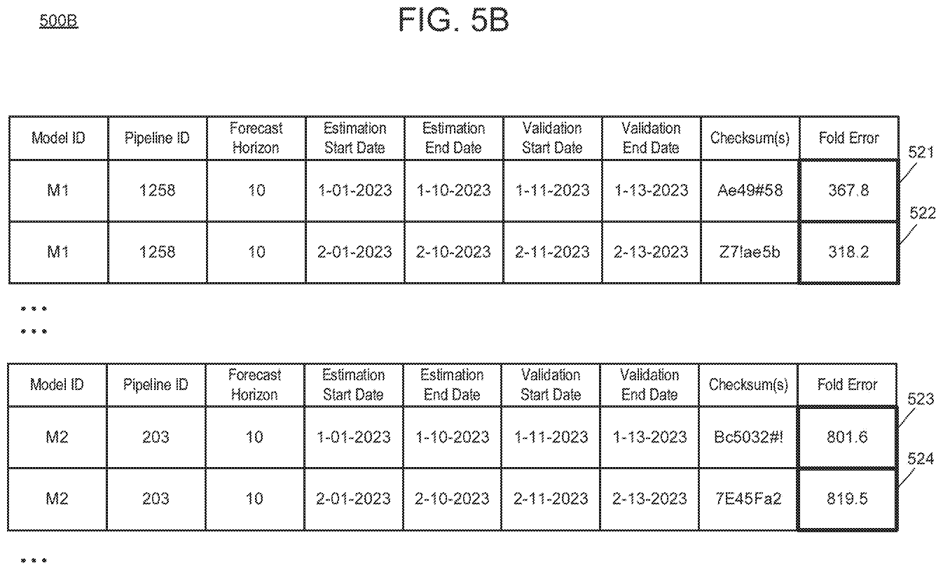

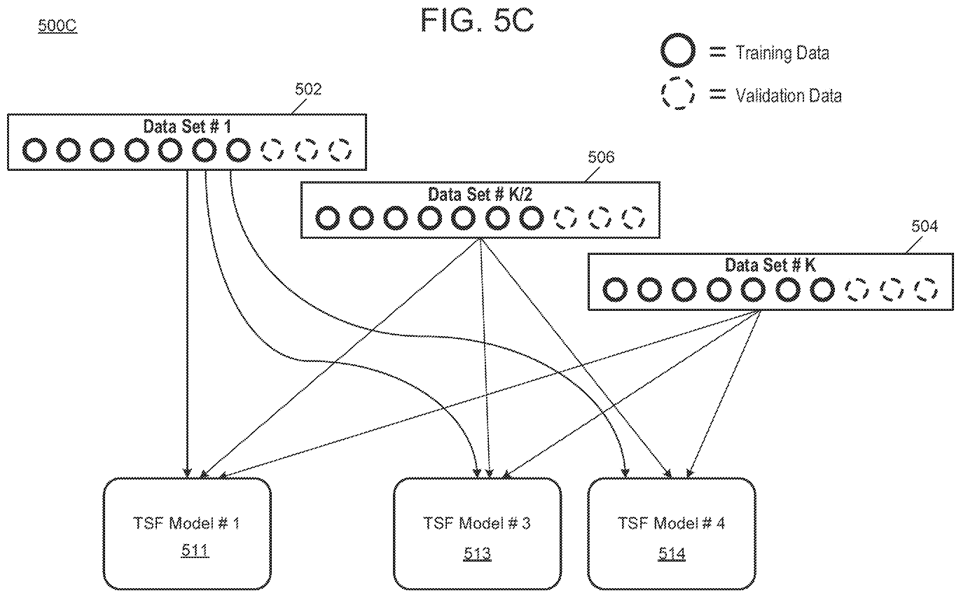

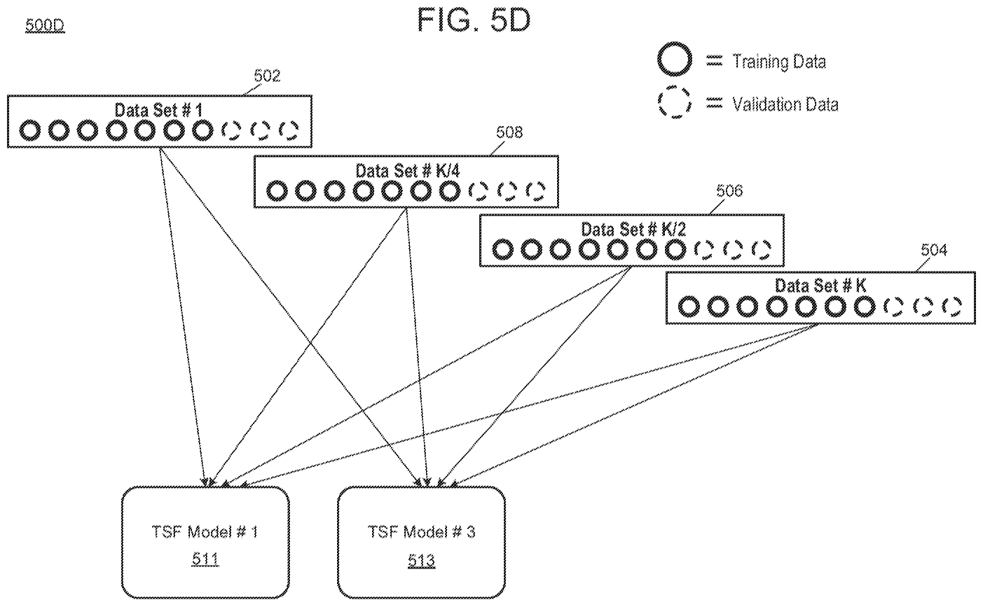

FIG. 4 illustrates a process 400 of reducing a training data set while training a TSF model in accordance with example embodiments. For example, the model training process may be part of a selection process that starts in 410 in response a scheduler initiating the process, etc. The process starts with model training, and then model selection. In this example, instead of applying an exhaustive error estimation for all model candidates (M1, M2, M3, M4) and for all folds of data during the training/retraining process, a dichotomic fold creation process is performed. For example, in 411, a subset of folds may be selected from the training data. An example of how the initial subset is selected is shown and described with respect to FIG. 5A. Here, the subset of folds may include the two extreme folds (e.g., the newest and oldest folds) from among a larger number of folds (e.g., 10 folds) in the data set. The newest fold may refer to the most recently generated fold and the oldest fold may refer to the oldest generated fold. These folds may refer to the folds that are held in storage, such as a fold error storage 402.

In 412, the host system may train the model candidates (machine learning models) based on training data in the folds and test the model candidates to determine the error rates of the models based on the validation data. As part of the training process, the host system may compute errors for all model candidates (M1, M2, M3, M4) at each of the folds, and compare the errors among the folds to generate fold errors for each of the model candidates. For example, by comparing an error of a newest fold and an oldest fold of the model M1, a fold error rate can be determined for the model M1 and the training data from where the folds are from. In 413, the system may update fold errors stored in the fold error storage 402 with freshly computed errors from the training process.

In 414, the host system can evaluate the errors, such as shown and described in the examples of FIGS. 5A-5D, to determine if any of the model candidates are finished training or if training needs to be continued. If the error between two folds is more than a threshold, then there is a good amount of error in the data, and additional training could be beneficial. In this case, the error ratio dictates whether more training is performed, and the error ratio is performed on a per model basis. Therefore, some of the models may be trained more than the others depending on the resulting error ratios that are generated by the models. Part of this process may include retraining the model again. To do this, in 415, the host system may select another fold (e.g., such as a halfway fold that is halfway in between the two extreme folds) as the next fold for training and validation. The process may repeat again until the process determines that the fold error is no longer greater than a threshold in 416.

FIG. 5A illustrates an initial training process 500A during which an oldest fold 502 (data set #1) and a newest fold 504 (data set #2) are selected from among a plurality of folds of training data. The folds may be the two extreme folds such as the first and last folds, earliest and newest folds, etc. In this example, models 511, 512, 513, and 514 are trained using the oldest fold 502 and the newest fold 504. Each model may be a time-series forecasting model which is trained on each fold resulting in an error value being output for each specific fold. An example of the outputs are shown in FIG. 5B.

FIG. 5B illustrates a table 500B of output results from the training of the model 511 and the model 512. Here, the table 500B includes a plurality of columns and a plurality of rows that create an array of cells. Each row corresponds to a training run of a model based on a particular fold of data. The columns include fields for model identifier, pipeline identifier, forecast horizon, estimation data start/end dates, validation data start/end dates, checksums, and fold error values.

In FIG. 5B, a first fold error 521 and a second fold error 522 generated from a model 511 can be compared to each other to determine whether the model 511 should be further retrained. Here, the host system may determine a difference between the first fold error 521 and the second fold error 522 (e.g., a percentage, ratio, etc.) and determine if the difference is large enough to warrant another round of training. The determination may be made by comparing a ratio/difference between the first fold error 521 and the second fold error 522 with a predefined threshold ratio/difference. If the ratio/difference is greater than the threshold, then additional training is scheduled.

Likewise, a first fold error 523 and a second fold error 524 generated from a model 512 can be compared to each other to determine whether the model 512 should be further retrained. Here, the host system may determine a difference between the first fold error 523 and the second fold error 524 (e.g., a percentage, ratio, etc.) and determine if the difference is large enough to warrant another round of training. In this example, the host system determines that the model 512 does not need more training because there is not enough error/difference in the data to warrant additional training for that particular model. However, the host system determines that the model 511 does warrant more training because the fold error ratio is great enough.

For a given model (e.g., the model 512), if such relative difference is small enough (<5%) and the fold distance k-1 is fairly small as well, the likelihood that the intermediate fold errors between the extreme folds are homogenous is high. This typically occurs when the signal is nearly stationary with no abrupt change in trend, seasonality or auto correlation. On such situation, there's no need to create all intermediate errors for the given model. Conversely, for a given model (e.g., the model 511) if this relative difference is too important (>=5%) or the fold distance is too high, there's a high probability that the intermediate errors between the two extreme folds are heterogenous and diverge from the fold errors at the extremes. On such situation, create a fold F (k/2) at the middle between F (1) and F (k) to increase locally the fold density as the model exhibits non uniform error distribution over test folds.

FIG. 5C illustrates a process 500C of adding another fold and retraining the remaining models within the training process. Here, dichotomic fold creation is performed by integrating a fold 506 that is halfway between the oldest fold 502 and the newest fold 504 based on time, into the training process and repeating the steps again to determine the fold error. However, because the model 512 was removed from the training process by the host system, the host system now only needs to train the models 511, 513, and 514. The same process can be repeated iteratively. For example, FIG. 5D illustrates a process 500D of performing a next iteration of the training process that adds yet another fold 508 to the training process. In this example, model 514 has been removed, and only models 511 and 513 remain. The process can repeat until the fold error is no longer above the threshold, or there are no more folds to analyze.

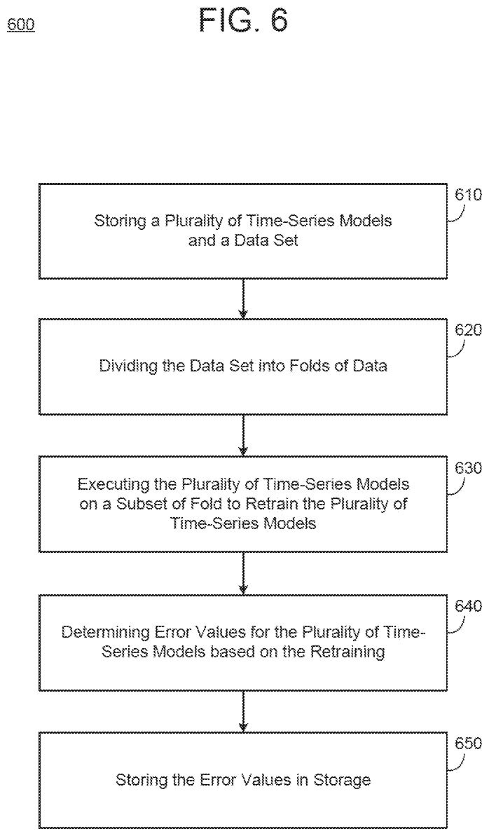

FIG. 6 illustrates a method 600 of training machine learning models for model selection in accordance with an example embodiment in accordance with an example embodiment. For example, the method 600 may be executed by a cloud platform, a web server, a database node, a user device such as a mobile phone, tablet, laptop, personal computer, etc., a combination of devices/nodes, or the like. Referring to FIG. 6, in 610, the method may include storing a plurality of machine learning models and a data set. The models may include different types of time series forecasting models with different algorithms (e.g., autoregression, moving average, autoregressive moving average, autoregressive integrated moving average, seasonal autoregressive interactive moving-average, and the like.

In 620, the method may include dividing the data set into k folds of data, where k is greater than 2. Each fold may include a predetermined number of data points (e.g., 5 data points, 7 data points, 10 data points, etc.) The data points within a fold may be split into two subsets including a first set of data points used for model training and a second set of data points that is used for testing the accuracy of the trained model. in 630, the method may include executing the plurality of machine learning models on a subset of folds from among the k folds of data to dynamically retrain the plurality of machine learning models. In 640, the method may include determining a plurality of error values for the plurality of machine learning models, respectively, based on fold errors among the subset of folds. In 650, the method may include storing the plurality of error values within the storage.

In some embodiments, the method may further include selecting a machine learning model from among the plurality of machine learning models for additional retraining based on an error value of the selected machine learning model, and executing the selected machine learning model on an additional fold from among the k folds of data to further retrain the selected machine learning model. In some embodiments, the method may further include selecting an additional fold from among the k folds, executing the selected machine learning model on the additional fold to further retrain the selected machine learning model, determining an error value for the selected machine learning model based on the further retraining, and determining whether or not to additionally retrain the selected machine learning model based on the error value.

In some embodiments, the method may further include selecting a second additional fold from among the k folds, executing the selected machine learning model on the second additional fold to even further retrain the selected machine learning model, determining an additional error value for the selected machine learning model based on the even further retraining, and determining whether or not to additionally retrain the selected machine learning model based on the additional error value. In some embodiments, the method may further include identifying a second machine learning model from among the plurality of machine learning models to stop retraining based on an error value of the second machine learning model, and terminate retraining of the second machine learning model.

In some embodiment, the method may further include selecting a fold with an earliest timestamp from among the k folds as the early fold and select a fold with a latest timestamp from among the k folds as the later fold. In some embodiments, the method may further include executing a machine learning model from among the plurality of machine learning models on the first fold and the last fold to generate two predicted outputs, comparing the two predicted outputs to two expected outputs to generate two fold error values, and comparing the two fold error values to determine whether to further retrain the machine learning model.

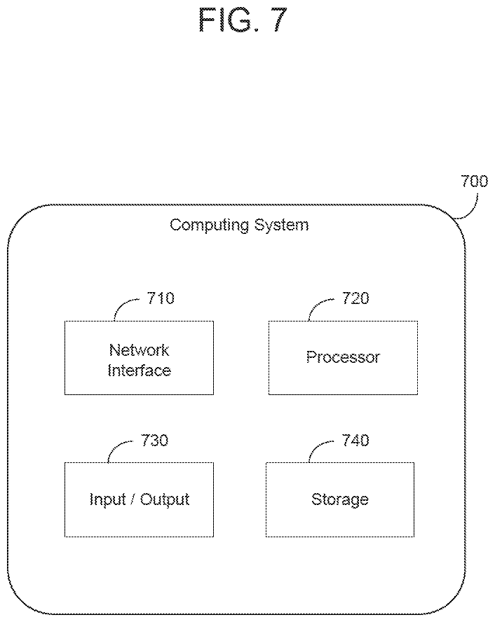

FIG. 7 illustrates a computing system 700 that may be used in any of the methods and processes described herein, in accordance with an example embodiment. For example, the computing system 700 may be a database node, a server, a cloud platform, or the like. In some embodiments, the computing system 700 may be distributed across multiple computing devices such as multiple database nodes.

Referring to FIG. 7, the computing system 700 includes a network interface 710, a processor 720, an input/output 730, and a storage 740 such as an in-memory storage, and the like. Although not shown in FIG. 7, the computing system 700 may also include or be electronically connected to other components such as a microphone, a display, an input unit(s), a receiver, a transmitter, a persistent disk, and the like. The processor 720 may control or replace any of the other components of the computing system 700.

According to various embodiments, the processor 720 may output a user interface to a local display or to a display of a remotely-connected device (e.g., via the network interface 710), which includes a user interface for inventory management as described in the example embodiments. The processor 720 may perform any of the method steps and processes described herein and any steps that would be reasonably understood to be performed with the steps and process not specifically mentioned such as generating API calls, generating SQL queries, database management services, rendering user interfaces, and the like.

The network interface 710 may transmit and receive data over a network such as the Internet, a private network, a public network, an enterprise network, and the like. The network interface 710 may be a wireless radio interface, a wired interface such as a network card, a satellite communication interface, a combination thereof, and the like. The processor 720 may include one or more processing devices each including one or more processing cores. In some examples, the processor 720 is a multicore processor or a plurality of multicore processors. Also, the processor 720 may be fixed or it may be reconfigurable. The input/output 730 may include an interface, a port, a cable, a bus, a board, a wire, and the like, for inputting and outputting data to and from the computing system 700. For example, data may be output to an embedded display of the computing system 700, an externally connected display, a display connected to the cloud, another device, and the like. The network interface 710, the input/output 730, the storage 740, or a combination thereof, may interact with applications executing on other devices.

The storage 740 is not limited to a particular storage device and may include any known memory device such as RAM, ROM, hard disk, and the like, and may or may not be included within a database system, a cloud environment, a web server, or the like. The storage 740 may store software modules or other non-transitory instructions which can be executed by the processor 720 to perform the methods and processes described herein. The storage 740 may include a data store having a plurality of tables, partitions and sub-partitions. The storage 740 may be used to store database records, items, entries, and the like. Also, the storage 740 may be queried using SQL commands.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e.., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store a plurality of time series models and a data set; and
a processor configured to
divide the data set into a k folds of data, where k is greater than two,
execute the plurality of time series models on a newest fold and an oldest fold from among the k folds of data to dynamically retrain the plurality of time series models,
determine a plurality of error values for the plurality of time series models, respectively, based on the newest fold and the oldest fold, and
store the plurality of error values within the storage.

2. The computing system of claim 1, wherein each fold of data includes a first subset of data for training and a second subset of data for validation.

3. The computing system of claim 1, wherein the processor is configured to select a time series model from among the plurality of time series models for additional retraining based on an error value of the selected time series model, and execute the selected time series model on an additional fold from among the k folds of data to further retrain the selected time series model.

4. The computing system of claim 3, wherein the processor is configured to select an additional fold from among the k folds, execute the selected time series model on the additional fold to further retrain the selected time series model, determine an error value for the selected time series model based on the further retraining, and determine whether or not to additionally retrain the selected time series model based on the error value.

5. The computing system of claim 4, wherein the processor is configured to select a second additional fold from among the k folds, execute the selected time series model on the second additional fold to even further retrain the selected time series model, determine an additional error value for the selected time series model based on the even further retraining, and determine whether or not to additionally retrain the selected time series model based on the additional error value.

6. The computing system of claim 1, wherein the processor is further configured to identify a second time series model from among the plurality of time series models to stop retraining based on an error value of the second time series model, and terminate retraining of the second time series model.

7. The computing system of claim 1, wherein the processor is configured to select a fold with a newest timestamp from among the k folds as the newest fold and select a fold with a oldest timestamp from among the k folds as the oldest fold.

8. The computing system of claim 1, wherein the processor is configured to execute a time series model from among the plurality of time series models on two folds from the k folds to generate two predicted outputs, compare the two predicted outputs to two expected outputs to generate two fold error values, and compare the two fold error values to determine whether to further retrain the time series model.

9. A method comprising:
storing a plurality of machine learning models and a data set;
dividing the data set into k folds of data, where k is greater than 2;
executing the plurality of machine learning models on a subset of folds from among the k folds of data to dynamically retrain the plurality of machine learning models;
determining a plurality of error values for the plurality of machine learning models, respectively, based on fold errors among the subset of folds; and
storing the plurality of error values within a storage.

10. The method of claim 9, wherein each fold of data includes a first subset of data for training and a second subset of data for validation.

11. The method of claim 9, wherein the method further comprises selecting a machine learning model from among the plurality of machine learning models for additional retraining based on an error value of the selected machine learning model, and executing the selected machine learning model on an additional fold from among the k folds of data to further retrain the selected machine learning model.

12. The method of claim 11, wherein the method further comprises selecting an additional fold from among the k folds, executing the selected machine learning model on the additional fold to further retrain the selected machine learning model, determining an error value for the selected machine learning model based on the further retraining, and determining whether or not to additionally retrain the selected machine learning model based on the error value.

13. The method of claim 12, wherein the method further comprises selecting a second additional fold from among the k folds, executing the selected machine learning model on the second additional fold to even further retrain the selected machine learning model, determining an additional error value for the selected machine learning model based on the even further retraining, and determining whether or not to additionally retrain the selected machine learning model based on the additional error value.

14. The method of claim 9, wherein the method further comprises identifying a second machine learning model from among the plurality of machine learning models to stop retraining based on an error value of the second machine learning model, and terminate retraining of the second machine learning model.

15. The method of claim 9, wherein the method further comprises selecting a fold with a newest timestamp from among the k folds and a fold with an oldest timestamp from among the k folds as the subset of folds.

16. The method of claim 9, wherein the method further comprises executing a machine learning model from among the plurality of machine learning models on a first fold and a last fold from the subset of folds to generate two predicted outputs, comparing the two predicted outputs to two expected outputs to generate two fold error values, and comparing the two fold error values to determine whether to further retrain the machine learning model.

17. A computer-readable medium comprising instructions which when executed by a processor cause a computer to perform a method comprising:
storing a plurality of machine learning models and a data set;
dividing the data set into k folds of data, where k is greater than 2;
executing the plurality of machine learning models on a subset of folds from among the k folds of data to dynamically retrain the plurality of machine learning models;
determining a plurality of error values for the plurality of machine learning models, respectively, based on fold errors among the subset of folds; and
storing the plurality of error values within a storage.

18. The computer-readable medium of claim 17, wherein each fold of data includes a first subset of data for training and a second subset of data for validation.

19. The computer-readable medium of claim 17, wherein the method further comprises selecting a machine learning model from among the plurality of machine learning models for additional retraining based on an error value of the selected machine learning model, and executing the selected machine learning model on an additional fold from among the k folds of data to further retrain the selected machine learning model.

20. The computer-readable medium of claim 19, wherein the method further comprises selecting an additional fold from among the k folds, executing the selected machine learning model on the additional fold to further retrain the selected machine learning model, determining an error value for the selected machine learning model based on the further retraining, and determining whether or not to additionally retrain the selected machine learning model based on the error value.
